(19) United States
(12) Patent Application Publication
(10) Pub. No.: US 2024/0070699 A1
(43) Pub. Date: Feb. 29, 2024

(54) SYSTEM AND METHOD FOR REWARDING USER ACTIVITY

(71) Applicant: Talk Hiring, Inc., New York, NY (US)

(72) Inventor: Harris G. Osserman, New York, NY (US)

(21) Appl. No.: 18/453,540

(22) Filed: Aug. 22, 2023

Related U.S. Application Data
(60) Provisional application No. 63/400,493, filed on Aug. 24, 2022.

(51) Int. Cl. G06Q 30/0207; G06Q 10/1053

(52) U.S. Cl. CPC G06Q 30/0207; G06Q 10/1053

(57) ABSTRACT

A system and method for rewarding user activity. When a user wants to obtain various opportunities, a user accesses a platform and provides information to the platform. The platform parses the information provided by the user and verifies the user's identity. The platform introduces the user to the platform. The user conducts a search of the platform to find opportunities compatible with the user's criteria. The platform may review the requirements of the opportunities and only show the user the opportunities that the user meets the requirements for. The user selects one or more opportunities and completes any information required by the platform. The platform verifies the opportunities that were selected by the user and/or whether the user obtained the opportunities by parsing the user's communications including digital communications. The user is rewarded for their activity on the platform.

### CROSS REFERENCE TO RELATED APPLICATIONS

The present application claims priority to U.S. Provisional Application 63/400,493 entitled EMPLOYMENT SEARCH REWARDS SYSTEM, and filed on Aug. 24, 2022, the entirety of which is hereby incorporated by reference herein, including any figures, tables, drawings, or other information.

### FIELD OF THE DISCLOSURE

This disclosure relates generally to a system and method for rewarding user activity, and in particular to providing a monetary reward to users during the job application and hiring process to sustainably support users that are applying for jobs.

### BACKGROUND OF THE DISCLOSURE

The process for searching for a job has changed dramatically over the years. Previously, job listings could be found in newspapers and resumes were reviewed by a human being. Now, most open jobs are posted online and anyone with access to the Internet can apply for them. As a result, the number of applicants per job posting has increased dramatically and a resume will be scanned by technology searching for appropriate qualifications before a human being sees it.

Due to the changing landscape, searching for and applying for jobs has become demanding and time consuming. Specifically, because of the increase in the use of technology, job seekers have access to more job postings and are expected to provide detailed information specific to the job that the job seeker is applying for. Further, some employers require multiple rounds of interviews and ask applicants to complete presentations, projects, or tests before they can be hired. As such, obtaining a job well suited for a job seeker may take a long time, especially for job seekers with limited access to technology and funds to sustain them while they are searching for a job.

Because of the challenging nature of searching for and applying for jobs, many job seekers make finding a job their full-time job even though they are not usually compensated for the time it takes them to find a job. Job seekers often feel that this level of dedication is needed to obtain a job that is a good fit for them. However, even though many job seekers make finding a job their top priority, it is impossible to predict how long the job searching process may take. As such, it can be challenging for job seekers to find a job in a cost-effective and efficient manner.

Although job seekers are one group that experience the challenge of sorting through and responding to a large amount of information in a cost-effective and efficient manner, other groups also struggle with these difficulties. For example, users who utilize online marketplaces to buy and sell products may also experience the need to dedicate a lot of time to the process to find a product and/or buyer for their product. These users may struggle to operate online marketplaces with limited access to technology and funds to sustain them while searching for a deal and/or a buyer. Additionally, users who must obtain a certification and/or accreditation to obtain a desired position may also find it challenging to navigate online systems to attend lectures and/or classes when they have limited access to technology and funds to sustain them during the process. Therefore, job seekers are only one of many groups that experience the challenge presented by spending a long time navigating online platforms without receiving a reward.

For the reasons stated above, and for other reasons which will become apparent to those skilled in the art upon reading and understanding the specification, there is a need in the art for systems and methods for rewarding users who are looking for jobs or conducting other time consuming, demanding, and/or complex tasks. Thus, it is a primary object of the disclosure to provide a system and method for rewarding users for their efforts.

These and other objects, features, or advantages of the present disclosure will become apparent from the specification and claims.

### BRIEF SUMMARY OF THE DISCLOSURE

The disclosure relates to systems and methods that reward user activity. This is achieved through a platform, wherein the platform is comprised of a receiver, a processor, and one or more opportunities. The receiver is configured to receive information from a user and the processor is configured to parse the information received from the user. The user can select opportunities provided by the platform and the platform will verify that the user selected an opportunity. When the processor verifies that the user selected an opportunity and submitted all necessary information required by the platform, the processor also parses the user's communications to and from third party sources. When the platform has verified that the user selected an opportunity and submitted the required information to the platform, the platform rewards the user.

### BRIEF DESCRIPTION OF THE DRAWINGS

FIG. 1 depicts a system diagram of an online system for rewarding user activity according to one embodiment.

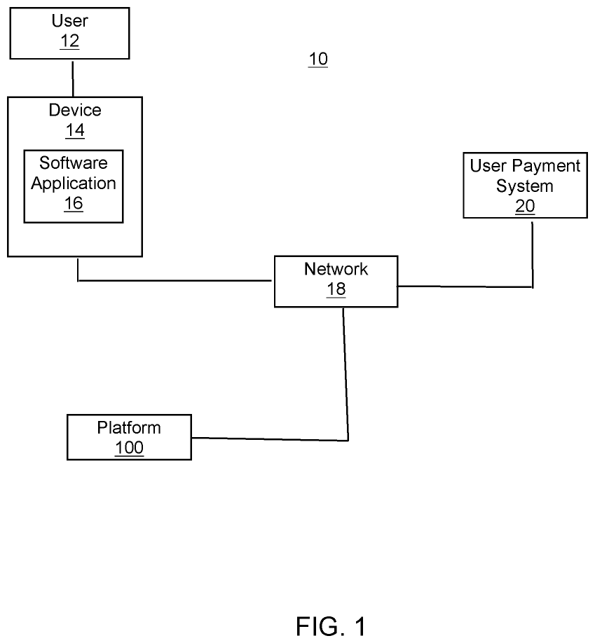

FIG. 2 depicts a block diagram illustrating the component parts of an online system for rewarding user activity according to one embodiment.

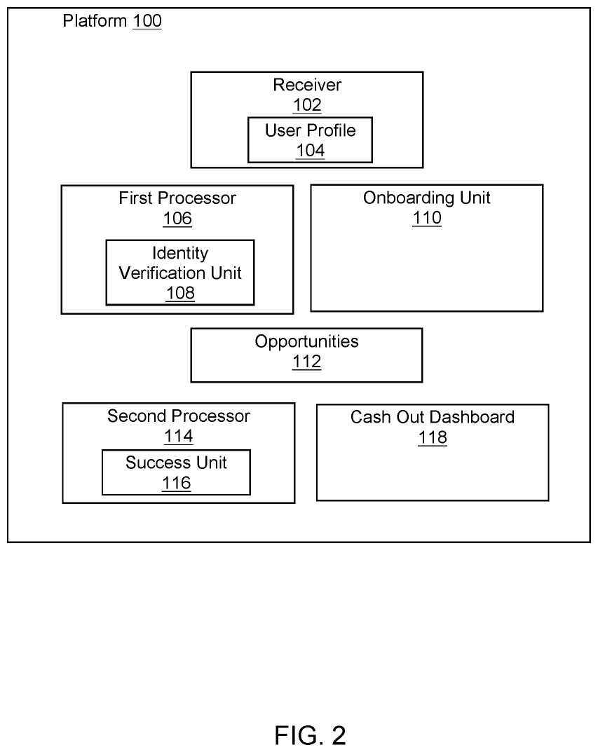

FIG. 3 depicts a flow diagram of a method for rewarding user activity according to one embodiment.

FIG. 4 depicts an exemplary user interface for presenting an opportunity to a user according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. Therefore, the following detailed description is not to be taken in a limiting sense, and the scope of the present disclosure is defined only by the appended claims, along with the full scope of equivalents to which such claims are entitled.

As used herein, the terms such as vertical, horizontal, top, bottom, front, back, end, and sides are referenced according to the presented views. It should be understood, however, that the terms are used only for purposes of description, and are not intended to be used as limitations. Accordingly, orientation of an object or a combination of objects may change without departing from the scope of the disclosure.

System 10

A system for rewarding user activity 10 is disclosed. In the arrangement shown, as one example, system 10 is comprised of a user 12, a device 14, a network 18, a platform 100, and a user payment system 20.

User 12

In one or more embodiments, a user 12 represents any number of seekers utilizing system 10 to obtain an opportunity 112. The user 12 is comprised of any device, system, or person who may be seeking an opportunity 112. Users 12 use devices 14 to accesses the platform 100 and provide data and/or information to the platform 100. However, any other suitable design is hereby contemplated for use without departing from the scope of the disclosure.

Device 14

In one or more embodiments, the user 12 uses one or more devices 14 to access the platform 100. The device 14 is configured to run a software application or browser 16. Device 14 may comprise any device that is or incorporates a computer such as a personal computer, desktop computer, laptop computer, a notebook, smartphone, tablet, or other device configured to run a software application or browser 16. A computer is a device configured to store and process data according to instructions given to it in a variable program. However, any other suitable design is hereby contemplated for use without departing from the scope of the disclosure.

Software Application 16

In one or more embodiments, a device 14 is configured to use a software application 16. A software application 16 is a computer program designed to carry out a specific task other than one relating to the operation of the device 14 itself. In one embodiment, the software application 16 may allow a user 12 to access the platform 100 directly. In an alternative embodiment, the software application 16 may be a web browser such as Microsoft Internet Explorer, Mozilla Firefox, Google Chrome, Apple Safari, Opera, and/or any other web browser. When a user 12 accesses a web browser software application 16, the user may find and access the platform 100. However, any other suitable design is hereby contemplated for use without departing from the scope of the disclosure.

Network 18

In one or more embodiments, a network 18 is configured to allow users 12 to communicate with the platform 100. In one embodiment, the network 18 may be the Internet. The Internet is a worldwide system of computer networks. In an alternative embodiment, the network 18 may be a private network that is separate from the Internet and dedicated for use by a single user 12. The network 18 uses standard communications, technologies, and/or protocols. However, any other suitable design is hereby contemplated for use without departing from the scope of the disclosure.

User Payment System 20

In one or more embodiments, a user payment system 20 is configured to communicate with platform 100 and is comprised of an online system that facilitates rewarding users 12 for their activity on platform 100. The rewards provided by the user payment system 20 may be, for example, money, products, points, and/or anything else which may comprise a reward. Further, the user payment system 20 may communicate with one or more banking systems, financial management systems, and/or asset management systems identified to the user payment system 20 by a user 12. However, any other suitable design is hereby contemplated for use without departing from the scope of the disclosure.

Platform 100

A platform 100 is disclosed and is comprised of various components utilized by system 10. In the arrangement shown, as one example, platform 100 is comprised of a receiver 102, a first processor 106, an onboarding unit 110, opportunities 112, a second processor 114, and a cash out dashboard 118.

Moreover, platform 100 may be used in a number of different embodiments. In one embodiment, for example, the platform 100 is configured to provide an employment marketplace wherein users 12 may select and apply for jobs posted by employers looking for job seekers and wherein the users 12 are rewarded for their activity on the platform 100. In an alternative embodiment, the platform 100 may be configured to provide a marketplace wherein users 12 may buy and/or sell products and be rewarded for their activity on the platform 100. In yet another alternative embodiment, the platform 100 may be configured to provide a system wherein users 12 can choose various lectures and/or classes from a list of lectures and/or classes and wherein the users 12 are rewarded based on how many lectures and/or classes they attend as well as the type of lectures and/or classes they attend, as recorded by the platform 100. However, any other suitable embodiments and/or designs are hereby contemplated for use without departing from the scope of the disclosure.

Receiver 102

In one or more embodiments, a receiver 102 is configured to receive information provided to the platform 100 by a user 12. The receiver 102 may be comprised of a database management system or any other system configured to store information. When a user 12 registers with the platform 100 and provides data and/or information to the platform 100, a receiver 102 records and stores the information. However, any other suitable design is hereby contemplated for use without departing from the scope of the disclosure.

In one or more embodiments, the receiver 102 may be comprised of one or more user profiles 104. A user profile 104 is comprised of information explicitly provided by a user 12. Information provided by a user 12 may include, but is not limited to, a user's name, email address, physical address, phone number, date of birth, work experience, education history, gender, references, skills, and other demographic and descriptive information. In addition to exhibiting the information provided to it by a user 12, a user profile 104 may also track user 12 initiated activity on the platform 100. However, any other suitable design is hereby contemplated for use without departing from the scope of the disclosure.

First Processor 106

In one or more embodiments, a first processor 106 is configured to parse the information stored in the user profile 104. When the platform 100 parses information, the platform 100 separates information into smaller components and translates it so that other components of the platform 100 can utilize the information. When the first processor 106 parses the information stored in the user profile 104, the first processor 106 will analyze the information to identify pre-determined keywords that match the keywords to various opportunities 112 on the platform 100. After parsing the information, the first processor 106 will be able to determine the opportunities 112 that contain keywords which match or correspond with the keywords contained in the information. Additionally, the first processor 106 will be able to identify any information that is suspicious by identifying keywords in the information that match or correspond with pre-determined suspicious keywords. However, any other suitable design is hereby contemplated for use without departing from the scope of the disclosure.

In one or more embodiments, the first processor 106 may be comprised of one or more identity verification units 108. In the event that the information a user 12 provides contains suspicious keywords as identified during the parsing process conducted by the first processor 106, the user 12 may be asked to provide additional identity verification documents such as, but not limited to, a government-issued identification documents, work certification verification documents, and/or any other information which may verify a user's 12 identity. After a user 12 provides the requested additional identity verification documents, the identity verification unit 108 will determine whether the user 12 will be allowed to continue accessing the platform 100 based on pre-determined criteria. However, any other suitable design is hereby contemplated for use without departing from the scope of the disclosure.

Onboarding Unit 110

In one or more embodiments, an onboarding unit 110 is configured to enable new users 12 to start using the platform 100. When a user 12 that has not accessed the platform 100 before provides information to the platform 100, creates a user profile 104, and allows the first processor 106 to parse the information that the user 12 provides, the onboarding unit 110 will work with the other components of the platform 100 to determine whether the user 12 has achieved a minimum level of verification. This minimum level of verification is subject to change based on a number of factors including, but not limited to, the prevalence of suspicious users 12 and/or activity on the platform 100, the amount of information provided by the user 12, and/or the speed that the onboarding unit 110 can determine the minimum level of verification. After the onboarding unit 110 determines that a user 12 has achieved a minimum level of verification, the onboarding unit 110 provides the user 12 access to documents, videos, audio recordings, etc. which provide the user 12 information on how the platform 100 operates. However, any other suitable design is hereby contemplated for use without departing from the scope of the disclosure.

Opportunities 112

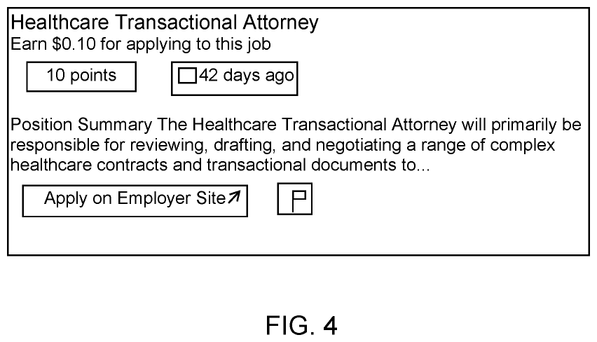

In one or more embodiments, the platform 100 is comprised of opportunities 112. Opportunities 112 may include, but are not limited to, job postings, job listings, product listings, product postings, lectures, classes, and any other opportunities for users 12. For example, one embodiment of an opportunity 112 is shown in FIG. 4. When a user 12 accesses and uses the platform 100 they may conduct a search for an opportunity 112. When a user 12 triggers a search of the platform 100, requests may be sent out in parallel to different aggregation application programming interfaces (“APIs”), extensible markup language (“XML”) feeds, etc. When conducting a search, a user 12 may narrow the results presented by the platform 100 according to applicable criteria. These applicable criteria may include, but are not limited to, location, work environment, the entity offering the opportunity, distance, price, pay, qualifications, size, content, etc. However, any other suitable design is hereby contemplated for use without departing from the scope of the disclosure.

Second Processor 114

A second processor 114 is configured to parse the information stored in the user profile 104 in one or more embodiments. When the second processor 114 parses the information stored in the user profile 104, the second processor 114 will analyze the information to identify pre-determined keywords that match the keywords to various opportunities 112 on the platform 100. After parsing the information, the second processor 114 will be able to determine the opportunities 112 that contain keywords which match or correspond with the keywords contained in the information. However, any other suitable design is hereby contemplated for use without departing from the scope of the disclosure.

Additionally, the second processor 114 may support the user 12 in finding opportunities 112 which correspond with the opportunities 112 that the user 12 is looking for. For example, after a user 12 conducts a search, the second processor 114 may process the keywords the user 12 uses in the search and may predict the most likely requirements, such as certifications, degrees, and/or passed exams that match the user's 12 included keywords. After the second processor 114 determines these likely requirements, the second processor 114 may ask the user 12 to identify these requirements in the information the user 12 provides to the platform 100 in the user profile 104. If the user 12 does not provide the required information, the second processor 114 may not include opportunities 112 which require those certain requirements in the user's 12 search results. However, any other suitable design is hereby contemplated for use without departing from the scope of the disclosure.

Moreover, some opportunities 112 may be identified by the platform 100 as high-cashback, because a user 12 may gain a large reward for selecting the opportunity 112. The criteria used by the platform 100 to determine whether an opportunity 112 is high-cashback may include, but is not limited to, cost of obtaining the opportunity 112, popularity of the opportunity 112 to users 12, and/or reimbursement to be paid by the poster of an opportunity 112. When an opportunity 112 is identified by the platform 100 as high-cashback, the second processor 114 may parse the opportunity 112 and restrict users 12 from selecting the opportunity 112 if keywords in the information the user 12 provided to the platform 100 are not reflected in the opportunity 112. However, any other suitable design is hereby contemplated for use without departing from the scope of the disclosure.

In one or more embodiments, the second processor 114 may be comprised of one or more success units 116. In one or more embodiments, success units 116 are configured to determine whether a user 12 receives a reward as well as what the reward is comprised of by tracking whether the user 12 selects an opportunity 112 and/or whether the user 12 successfully obtains the selected opportunity 112. In order to track the user's 12 activity, the user 12 allows the success units 116 access to the user's personal email account wherein the user 12 sends and receives notifications regarding selected opportunities 112 and/or whether the user 12 obtained the selected opportunities 112. However, any other suitable design is hereby contemplated for use without departing from the scope of the disclosure.

In one or more embodiments, the success units 116 may prompt a user 12 to access a separate email address that the platform 100 automatically creates for the user 12. This is a forwarding email and every email sent to the email address will be forwarded to a user's 12 personal email address. The platform 100 makes it easy for users 12 to use this email address by giving them a “copy this email address” button, and requiring that the user 12 copy it before getting redirected to the opportunities 112 accessible through the platform 100. However, any other suitable design is hereby contemplated for use without departing from the scope of the disclosure.

In one or more embodiments, when the platform 100 gains access to a system which manages a user's 12 communications including digital communications which include, but are not limited to, emails, text messages, instant messages, and/or phone calls, the success units 116 may parse the communications received by and sent by the user 12. When the success units 116 parse a user's 12 communications, the success units 116 determine whether a user 12 selected an opportunity 112 and/or whether the user 12 obtained the opportunity 112 by reviewing the keywords contained in the user's 12 communications and matching them to keywords related to opportunities 112 hosted on the platform 100. The content of these keywords may include, but is not limited to, the name of the entity sending the communication, the email address used to send the communication, the subject line of the communication, and/or the email domain of the communication. However, any other suitable design is hereby contemplated for use without departing from the scope of the disclosure.

Alternatively, in one or more embodiments, for opportunities 112 that reward a cost-per-application (“CPA”) from a recruitment service, the success units 116 of the platform 100 receive a webhook hypertext transfer protocol (“HTTP”) request from the recruitment service every time that a user 12 from the platform 100 applies to a recruitment service CPA job. Then, the recruitment services will inform the platform 100 of the opportunity 112 selected by a user 12. The success units 116 may also verify the information provided by the recruitment service by cross-referencing the information provided by the recruitment service with the information stored on the platform 100 related to the users 12 that have accessed the relevant opportunities 112. However, any other suitable design is hereby contemplated for use without departing from the scope of the disclosure.

Alternatively, in one or more embodiments, the success units 116 may determine whether a user 12 selected an opportunity 112 by reviewing on-site submission experiences and integrations into an opportunity 112 poster's Application Tracking Systems (“ATS”) APIs. However, any other suitable design is hereby contemplated for use without departing from the scope of the disclosure.

Cash Out Dashboard 118

In one or more embodiments, a cash out dashboard 118 is configured to reward users 12 for selecting opportunities 112, using the platform 100, and/or obtaining opportunities 112. The cash out dashboard 118 determines the reward a user 12 receives for each opportunity 112. The reward users 12 receive is variable and may be based on applicable criteria such as market conditions and user 12 competition, among other criteria. When the cash out dashboard 118 estimates what an opportunity's 112 poster may pay the platform 100 to get a user 12 to select or apply for an opportunity 112, the cash out dashboard 118 uses that estimate to dynamically price the cash back that a user 12 earns for selecting the opportunity 112. Rewards may be reflected in points, monetary value, and/or other tracking mechanisms. When the platform 100 has determined that a user's 12 rewards have reached a particular threshold, a user 12 will be allowed to connect their desired cash out destination to the platform 100 via an electronic payment system and move their rewards to their desired system. Without departing from the scope of the disclosure, the particular threshold that a user's 12 rewards must reach is pre-determined by the operator of platform 100. The reward may be transferred via Automated Clearing House (“ACH,”) or any other transfer mechanism. The cash out dashboard 118 is also configured to calculate the reward that each user 12 is owed at regular intervals. Without departing from the scope of the disclosure, such regular intervals may be 15 minute intervals, weekly intervals, or any other interval period as contemplated herein.

Further, users 12 may utilize the cash out dashboard 118 to review how many rewards they have obtained and when rewards have been moved to and from the platform 100. If a user 12 does not remove their rewards from the cash out dashboard 118, the platform 100 may automatically transfer the reward to the user's 12 desired cash out destination. However, any other suitable design is hereby contemplated for use without departing from the scope of the disclosure.

Method 200

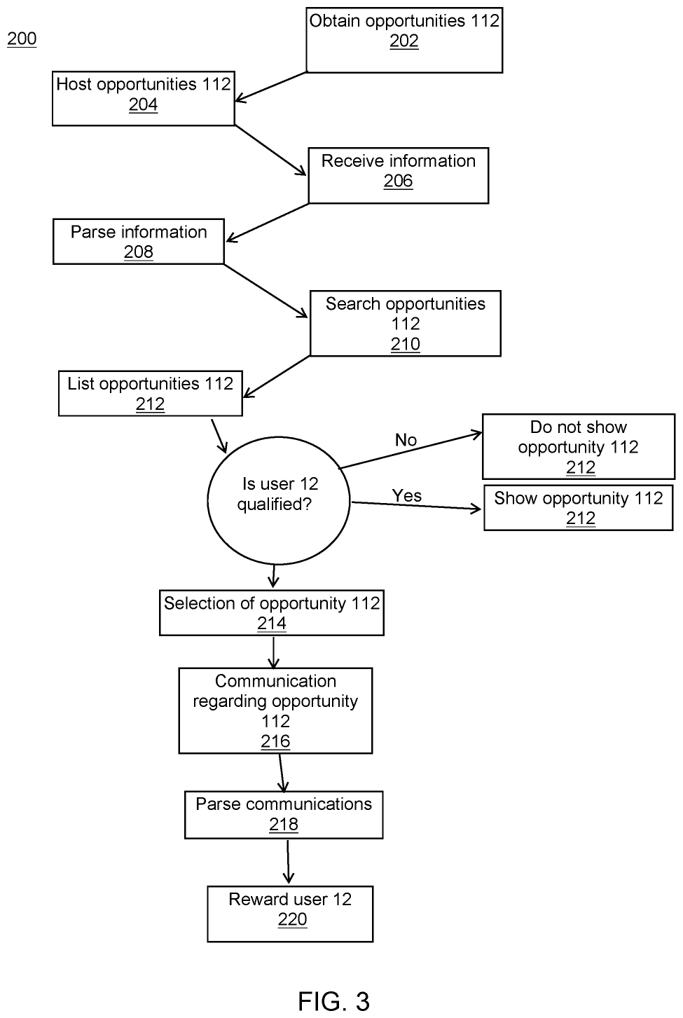

As shown in FIG. 3, a method 200 for rewarding user 12 activity on the platform 100 begins at step 202 in which the platform 100 obtains opportunities 112 from various sources such as aggregation API and XML parties. These parties support the platform 100 by paying the platform 100 a cost-CPA or a cost-per-click (“CPC”). Additionally, opportunities 112 may also be obtained from posters themselves.

At step 204, platform 100 hosts the opportunities 112 obtained from step 202 on the platform 100 so that users 12 can view and access the opportunities 112.

At step 206, the receiver 102 of platform 100 receives information from a user 12 and a user profile 104 is created for the user 12 which stores the user 12 provided information.

At step 208, the first processor 106 of platform 100 parses the information provided by a user 12. In the event that the information a user 12 provides contains suspicious keywords as identified during the parsing process, the user 12 may be asked to provide additional identity verification documents to the identity verification unit 108 of the first processor 106. Additionally, at step 208, a user 12 is allowed access to the onboarding unit 110 which introduces user 12 to the platform 100 and how the platform 100 functions.

At step 210, the user 12 searches the platform 100 for opportunities 112. The user 12 may narrow the results presented by the platform 100 according to applicable criteria. These applicable criteria may include, but are not limited to, location, work environment, the entity offering the opportunity, distance, price, pay, qualifications, size, content, etc.

At step 212, the platform 100 compiles a list of opportunities 112 according to the user's 12 applicable criteria. At this step 212, the second processor 114 may support the user 12 in finding opportunities 112 which correspond with the opportunities 112 that the user 12 is looking for. For example, the second processor 114 will review the information provided by the user 12 and determine whether the user 12 meets the requirements of opportunities 112 hosted on the platform 100. If the user 12 does not meet the requirements of an opportunity 112, the second processor 114 will not allow the platform 100 to show the opportunity 112 to the user 12. In contrast, if the user 12 meets the requirements of an opportunity 112, the second processor 114 will allow the platform 100 to show the user 12 the opportunity 112.

At step 214, a user 12 selects an opportunity 112 that the user 12 would like to obtain. When the user 12 selects an opportunity 112, the user 12 sends a communication to the platform 100 and/or the poster of the opportunity 112.

At step 216, a user 12 may send a communication to or receive a communication from the poster of an opportunity 112 regarding the user's 12 selection of the posted opportunity 112. This communication may be in any form, including, but not limited to, an email, a text message, an instant message, and/or a phone call.

At step 218, the success unit 116 of the second processor 114 reviews and parses the user's communications of steps 214 and 216. At step 218, the success unit 116 reviews these communications to determine the reward that the user 12 should receive for their activity on the platform 100.

At step 220, the cash out dashboard 118 of the platform 100 provides the user 12 a reward for selecting opportunities 112, using the platform 100, and/or obtaining opportunities 112.

The system 10, platform 100, and method 200 have many benefits and advantages including, but not limited to rewarding users 12 for their activity. These and other benefits and advantages are apparent from the specification and claims.

Aspects of the present disclosure are described above with reference to block diagrams of methods, systems, and computer program products according to embodiments in which the disclosure may be practiced. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Persons of ordinary skill in the art may appreciate that numerous design configurations may be possible to enjoy the functional benefits of the present disclosure. Thus, given the wide variety of configurations and arrangements of embodiments of the present disclosure, the scope of the disclosure is reflected by the breadth of the claims below rather than narrowed by the embodiments described above.

### REFERENCE NUMERALS

10—System
12—User
14—Device
16—Software application
18—Network
20—User payment system
100—Platform
102—Receiver
104—User profile
106—First processor
108—Identify verification unit
110—Onboarding unit
112—Opportunities
114—Second processor
116—Success unit
118—Cash out dashboard
200—Method
202—Obtain opportunities 112
204—Host opportunities 112
206—Receive information
208—Parse information
210—Search opportunities 112
212—List opportunities 112
214—Selection of opportunity 112
216—Communication regarding opportunity 112
218—Parse communications
220—Reward user 12

What is claimed:

1. A computer implemented system for tracking and rewarding user activity, comprising:
a platform;
wherein the platform is comprised of a receiver, a processor, and one or more opportunities;
wherein the receiver is configured to receive information from a user;
wherein the processor is configured to parse the information received from the user;
wherein the user selects an opportunity;
wherein the processor verifies that the user selected the opportunity;
wherein when the processor verifies that the user selected the opportunity, the processor parses the user's communications; and
wherein the platform rewards the user for selecting the opportunity.

2. The system of claim 1, wherein the platform is comprised of a plurality of opportunities.

3. The system of claim 1, wherein when the processor parses the information received from the user, the processor determines whether a keyword included in the opportunities corresponds to a keyword included in the information.

4. The system of claim 1, wherein the user selects a plurality of opportunities from the one or more opportunities provided by the platform.

5. The system of claim 1, wherein the user's communications include one or more of a digital communication, a verbal communication, or a physical communication.

6. The system of claim 1, wherein when the processor parses the user's communications, the processor determines whether a pre-determined keyword corresponds to a keyword included in the communications.

7. The system of claim 1, wherein the user is rewarded for selecting the opportunity with money.

8. A computer implemented method, comprising:
hosting one or more opportunities on a platform;
receiving information received from a user;
parsing the information received from the user;
wherein the user selects an opportunity;
verifying that the user selected the opportunity;
parsing the user's communications to verify that the user selected the opportunity; and
rewarding the user for selecting the opportunity.

9. The method of claim 8, wherein hosting the one or more opportunities on the platform comprises: removing the one or more opportunities from the platform; updating the one or more opportunities from the platform; and adding the one or more opportunities to the platform.

10. The method of claim 8, further comprising, prior to when the user selects the opportunity, determining whether any of the one or more opportunities include a keyword corresponding with a keyword included in the information received from the user.

11. The method of claim 8, wherein receiving the information from the user comprises: the user providing information and storing the information received from the user.

12. The method of claim 8, further comprising, prior to when the user selects the opportunity, restricting user access to one or more opportunities that include a keyword that is also included in the information received from the user.

13. The method of claim 8, further comprising, prior to rewarding the user for selecting the opportunity, determining whether any of the user's communications include a keyword corresponding with a pre-determined keyword to verify that the user selected the opportunity.

14. The method of claim 8, further comprising, prior to rewarding the user for selecting the opportunity, determining the appropriate reward for the user.

15. The method of claim 8, wherein rewarding the user comprises providing the user access to money.

16. The method of claim 8, wherein the user's communications include one or more of a digital communication, a verbal communication, or a physical communication.

17. A non-transitory computer readable medium storing executable computer program instructions, the computer program instructions comprising instructions that when executed cause a computer processor to:
provide one or more opportunities on a platform;
receive information from a user;
parse the information received from the user;
determine whether any of the one or more opportunities include a keyword corresponding with a keyword included in the information received from the user;
wherein the user selects an opportunity;
verify whether the user selected the opportunity;
parse the user's communications;
determine whether any of the user's communications include a keyword corresponding with a pre-determined keyword to verify that the user selected the opportunity; and
reward the user for selecting the opportunity.

18. The non-transitory computer readable medium of claim 17, wherein the computer program instructions for rewarding the user comprise instructions that when executed cause the computer processor to determine the appropriate reward for the user.

19. The non-transitory computer readable medium of claim 17, wherein the computer program instructions for rewarding the user comprise instructions that when executed cause the computer processor to provide the user access to money.

20. The non-transitory computer readable medium of claim 17, wherein the user's communications include one or more of a digital communication, a verbal communication, or a physical communication.
